(19) United States
(12) Patent Application Publication
(10) Pub. No.: US 2018/0134060 A1
(43) Pub. Date: May 17, 2018

(54) INK TRANSFER MEDIUM

(71) Applicant: ContiTech Elastomer-Beschichtungen GmbH, Hannover (DE)

(72) Inventors: Bjoern Heise, Goettingen (DE); Stefan Fuellgraf, Duderstadt (DE); Markus Gnass, Hattorf am Harz (DE); Jan Leonhardt, Adelebsen (DE)

(21) Appl. No.: 15/870,248

(22) Filed: Jan. 12, 2018

Related U.S. Application Data
(63) Continuation of application No. PCT/EP2016/054184, filed on Feb. 29, 2016.

(30) Foreign Application Priority Data
Jul. 13, 2015 (DE) 102015213057.6

(51) Int. Cl. B41N 10/04; B41F 5/24

(52) U.S. Cl. CPC B41N 10/04; B41N 2210/04; B41F 5/24

(57) ABSTRACT

An ink transfer medium, in particular a printing blanket, in particular a printing blanket for flexographic printing, has a cover layer for transferring an ink via a printing side and an adhesive layer for fastening the ink transfer medium to a base, in particular to a cylinder of a printing machine. The ink transfer medium is characterized by a support layer which is disposed between the cover layer and the adhesive layer, wherein the adhesive layer is disposed directly on that side of the support layer that faces away from the printing side, and wherein the support layer is a film/foil.

### CROSS REFERENCE TO RELATED APPLICATIONS

This application is a continuation application of international patent application PCT/EP2016/054184, filed Feb. 29, 2016 designating the United States and claiming priority from German application 10 2015 213 057.6, filed Jul. 13, 2015, and the entire content of both applications is incorporated herein by reference.

### FIELD OF THE INVENTION

The invention relates to an ink transfer medium, in particular a printing blanket, in particular a printing blanket for flexographic printing.

### BACKGROUND OF THE INVENTION

In the field of flexographic printing, flexible printing plates which can be produced as printing blankets and can be wound onto the printing cylinder are used. A printing blanket usually has a multi-layered construction. That layer that in the height is the external layer is the cover layer, the surface of the latter being aligned toward the object to be printed and serving for transferring the ink. The relief to be printed can be machined into the cover layer by means of laser engraving, for example, such that raised regions of the cover layer to which the ink can adhere and be transferred to the surface of the object to be printed can be configured (relief printing method). The depressed regions, the material of the latter having being removed by the laser engraving, for example, are not intended for the transfer of ink.

The printing blanket on that side of the cover layer that faces away from the external surface of the cover layer can have a first woven fabric layer as a first strength support layer which can serve for regulating the conveying behavior in the printing machine and serve for the shape-related stability in the height (thickness) and in the width of the printing blanket. Next, a compressible layer which can regulate the hardness of the material of the printing blanket and the conveying behavior of the material can be provided.

A second woven fabric layer as a second strength support layer which can be configured as a single-layer or multiple-layer woven fabric can be present as the fourth layer. This second strength support layer can likewise serve for the dimensional stability in the height and in the width and additionally in the longitudinal direction, that is, in the revolving direction of the printing cylinder. The woven fabric can be configured so as to be natural, that is, from natural fibers, synthetic, that is, from chemical or man-made fibers, respectively, or so as to be a hybrid.

The fastening of the printing blanket to the smooth external side of the usually metallic printing cylinder can be performed by adhesive bonding. To this end, an adhesive layer which upon contact can produce a materially integral connection to the external side of the printing cylinder, that is, to the external surface of the printing cylinder, can be provided on the lower side of the printing blanket such as, for example, on the internal surface of the second strength support layer, that is, on the internal side of the printing blanket that faces the printing cylinder. This adhesive layer can usually be produced by way of a double-sided adhesive tape.

It is disadvantageous in the use of a woven fabric as the second strength support layer that the woven fabric under the stress of use can lose thickness, that is, can collapse. The reason for this can be explained in that the woven fabric fibers are composed of filaments which can contain air pockets. In the course of the use of the printing blanket, this air can be squeezed out of the woven fabric on account of which this second strength support layer can be compressed in terms of height and thus become flatter. Therefore, the second strength support layer in this form can have an insufficient dimensional stability in terms of height, that is, in terms of thickness.

It is furthermore disadvantageous that the second strength support layer by virtue of the woven fabric structure thereof toward the adhesive layer can have a non-planar surface, that is, that the filaments of the woven fabric can form an undulated surface. On account thereof, merely punctiform contacts between the elevations of the woven fabric of the second strength support layer and the adhesive layer can arise, which can weaken the adhesive force between the adhesive layer and the remainder of the printing blanket. Furthermore, liquids such as, for example, chemical printing inks which are used in printing can make their way into the porous woven fabric of the second strength support layer and cause the latter to swell, that is, enlarge the thickness of the second strength support layer. This can occur in particular on the peripheries such that a non-uniform thickness of the printing blanket can arise, potentially compromising the quality of the printing. Also, the liquid that has been absorbed into the woven fabric can weaken the connection between the adhesive layer and the second strength support.

### SUMMARY OF THE INVENTION

It is an object of the invention to provide an ink transfer medium, in particular a printing blanket, in particular a printing blanket for flexographic printing, such that the adhesive connection between the printing cylinder and the printing blanket can be improved.

The object can, for example, be achieved by an ink transfer medium having: a cover layer having a printing side and being configured to transfer an ink via the printing side; an adhesive layer for fastening the ink transfer medium to a base; a support layer disposed between the cover layer and the adhesive layer and having a first side facing away from the printing side; the adhesive layer being disposed directly on the first side of the support layer; and, the support layer being at least one of a film and a foil.

The present invention thus relates to an ink transfer medium which is preferably a printing blanket and particularly preferably is a printing blanket for flexographic printing. The ink transfer medium has a cover layer for transferring an ink via a printing side. The cover layer represents the external layer in the outward direction, which can receive ink and transfer ink to an object to be printed. The term “printing blanket” can thus mean a cylindrical printing plate as well as a planar printing plate, depending on the type of application and the type of the printing method.

The ink transfer medium furthermore has an adhesive layer for fastening the ink transfer medium to a base, in particular to a cylinder of a printing machine. On account thereof, the ink transfer medium can be connected to the printing cylinder in a materially integral manner and in this way when in operation, that is, when printing, can be held on the printing cylinder such that the cover layer, or the printing side of the latter, respectively, can assume its function.

The ink transfer medium is characterized by a support layer which is disposed between the cover layer and the adhesive layer. Yet further layers can be disposed between the cover layer and the adhesive layer. The adhesive layer here is however disposed directly on that side of the support layer that faces away from the printing side, such that optional further layers can be disposed only between the cover layer and the support layer.

The support layer is furthermore a film/foil. This is to be understood as a layer that in terms of height is very thin and which is composed of a plastic material or of a metallic material, or comprises a plastic material or a metallic material, respectively. A plurality of plastic materials or metallic materials, respectively, can be used in order for the properties thereof to be utilized in a combined manner. The film/foil is preferably composed of a plastic material. This can simplify the production.

This invention herein is based on the concept that the support layer can be produced from plastic or metal without any air pockets at all, or be produced without air pockets which can degenerate in the course of the operation of the printing blanket, respectively. The resilience in the height of that layer of the printing blanket to which the adhesive layer adheres can be avoided in this way. This can lead to an increased dimensional stability in the height. The longer service life of the printing blanket that is caused on account thereof can lead to higher life cycles and thus to lower costs.

It is also advantageous herein that cavities in this layer into which liquids such as, in particular, printing chemicals can ingress, which could then cause the printing blanket to swell, can be avoided. These liquids could also have a negative effect on the adhesive connection and compromise the effectiveness of the latter. The avoidance of these problems can increase the printing quality that is achievable by the printing blanket as the printing plate, or can help sustain the printing quality.

It is furthermore advantageous herein that a film/foil from plastic or metal as a support layer can have a very high shape-related stability in terms of area, that is, in the width and in the longitudinal direction or the circumferential direction, respectively, of the cylindrical printing blanket (in the printing direction). This is particularly advantageous with a view to engraving the cover layer, because the motive that is engraved in the cover layer and is to be transferred should have as high a positioning accuracy (register stability) as possible, and the latter can be facilitated by a high shape-related stability of the printing blanket in terms of area. Shape-related stability of the printing blanket herein is to be understood as that the material of the printing blanket at the operative point, or in the operating region, respectively, has a high rigidity, that is, has a high increase in force accompanied by low elongation. This herein is an elastic deformation (a straight line according to Hooke's law), that is, a linear correlation between force and elongation.

A double-sided adhesive tape which can be applied to the lower side of the support layer can be used as the adhesive layer. Alternatively, the lower side of the support layer can also be provided with a layer of applied adhesive means.

According to an aspect of the present invention the film/foil in relation to the adhesive layer has a smooth surface. A smooth surface is understood to be a roughness Rz of equal to or less than 10 μm. This aspect of the invention herein is based on the concept that an adhesive effect can be all the more positive the larger the planar contact between the surfaces to be connected. The adhesion in relation to the adhesive layer, both as a double-sided adhesive tape or else as a coating of adhesive means, can be improved by way of as smooth a surface of the support layer as possible. This can increase the life cycle of the printing blanket and thus cause a cost saving.

According to a further aspect of the present invention, the film/foil is a plastic film which is composed of polyester, or comprises polyester, respectively. As a plastic, this material can meet the aforementioned properties, and thus attain the advantages that are achievable on account thereof. Moreover, polyester is cost-effective in the production and is easy to process. Furthermore, a support layer from polyester can also cause a high dimensional stability in terms of area, that is, in the width and in the longitudinal direction.

According to a further aspect of the invention, the film/foil is a metal foil which is composed of metal, or comprises metal, respectively. The aforementioned properties and advantages can be implemented in the alternative manner by way of a thin metal foil as the support layer.

According to a further aspect of the present invention, the adhesive layer is disposed as a double-sided adhesive tape by way of winding. On account thereof, the adhesive layer can be applied to the printing blanket in a simple and rapid manner on site, that is, directly onto the printing cylinder, such that the adhesive layer does not have to be applied in advance and be protected from drying out and/or from contamination, which could represent an additional effort. Also, the decision as to which locations, or to which thickness, respectively, the adhesive tape is to be applied or disposed, respectively, between the printing blanket and the printing cylinder can be made directly on the printing cylinder.

According to a further aspect of the present invention, the adhesive layer is disposed on the film/foil by way of application. The application can be performed by spraying or wetting, for example. This can preferably be performed as the last method step in the context of the production of the printing blanket. The applied adhesive layer can thereafter preferably be provided with a protection against drying out and/or contamination.

It is advantageous herein that the printing blanket together with the adhesive layer can be shipped to the printing press or the like, such that the printing blanket there can be directly, or optionally upon the removal of a protective layer, applied to the printing cylinder by way of the adhesive layer. This can simplify and accelerate the fitting to the printing cylinder.

According to a further aspect of the present invention, the ink transfer medium furthermore has a strength support layer which is disposed between the cover layer and the support layer. The strength support layer is preferably disposed directly between the cover layer and the support layer. The strength support layer can serve for regulating the conveying behavior in the printing machine and serve for the shape-related stability in the height (thickness) and in the width of the printing blanket.

According to a further aspect of the present invention, the ink transfer medium furthermore has a compressible layer which is disposed between the cover layer and the support layer, preferably between the strength support layer and the support layer. The compressible layer preferably has a compressibility of more than 150 μm at an impingement of 135 N/cm². The compressible layer is preferably disposed directly between the cover layer and the support layer, or directly between the strength support layer and the support layer, respectively. The hardness of the material of the printing blanket and the conveying behavior of the material can be regulated by way of the compressible layer.

According to a further aspect of the present invention, the cover layer is composed of an elastomeric material, or comprises an elastomeric material, respectively. It is advantageous herein that the cover layer in this way can have a good engraving capability.

According to a further aspect of the present invention, precisely the following layers are present from the outside to the inside, and as the ink transfer medium are disposed in this sequence:

cover layer,

strength support layer,

compressible layer,

support layer, and

adhesive layer.

The use of all these layers causes the advantages that have been described individually above. The disposal of the layers in this sequence can ensure the optimal effect of the individual layers.

### BRIEF DESCRIPTION OF THE DRAWINGS

The invention will now be described with reference to the drawings wherein:

FIG. 1 shows a lateral schematic sectional illustration of an ink transfer medium according to the prior art; and,

FIG. 2 shows a lateral schematic sectional illustration of an ink transfer medium according to an embodiment of the present invention.

### DESCRIPTION OF THE PREFERRED EMBODIMENTS OF THE INVENTION

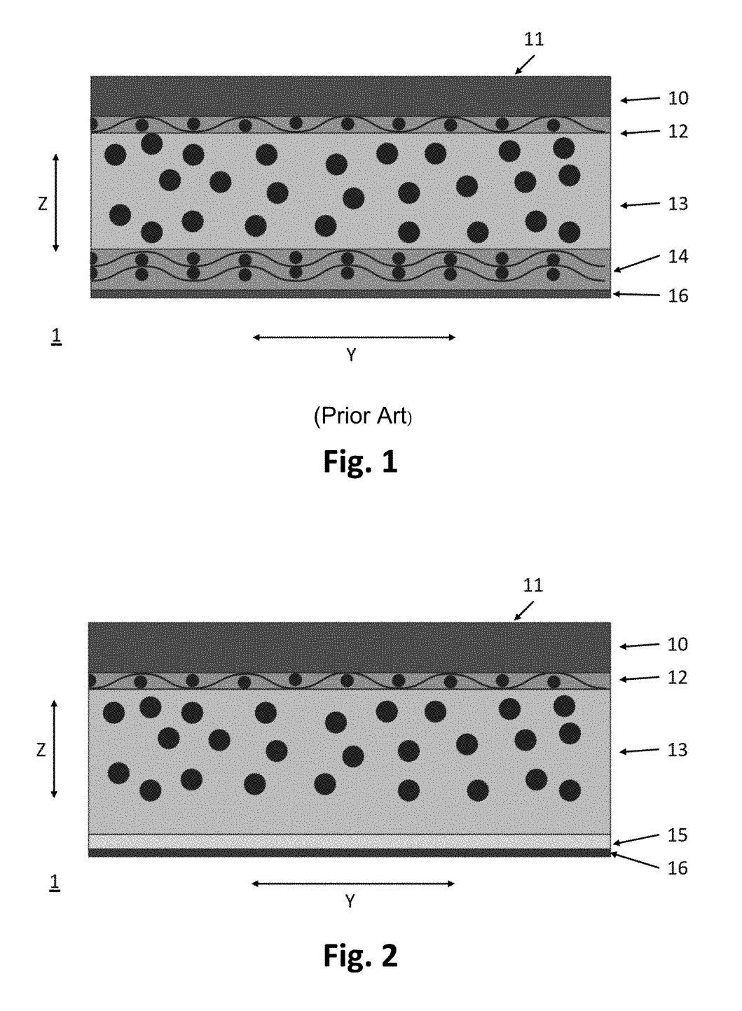

FIG. 1 shows a lateral schematic sectional illustration of an ink transfer medium 1 according to the prior art. The ink transfer medium 1 is a printing blanket 1 which in the state in which the latter is spread out in a planar manner, for example after production or when being cut to size, extends in a horizontal plane in a longitudinal direction Y and a transverse direction (not illustrated). The height Z, or the thickness Z, respectively, extends perpendicularly thereto. If the printing blanket 1 is cut to size and attached to a printing cylinder (not illustrated), the longitudinal direction Y thus becomes the circumferential direction Y in which the printing blanket 1 as the printing plate 1 is disposed about the cylindrical circumference of the printing cylinder.

The upper side of the printing blanket 1 in the illustration of FIG. 1 herein represents the upper side of the printing blanket 1 which becomes the external side of the printing plate 1. Accordingly, the lower side of the printing blanket 1 in the illustration of FIG. 1 herein represents the lower side of the printing blanket 1 which becomes the internal side of the printing plate 1.

In the height Z the printing blanket 1 of FIG. 1 according to the prior art has a cover layer 10 which in the case of the printing plate 1 can be referred to as the cover plate 10. The upper external side of the cover layer 10 represents the printing side 11 of the cover layer 10 which, for example by laser engraving, can be used for configuring a relief. For this reason, the cover layer 10 preferably has a predetermined minimum thickness in order to offer sufficient material in the height Z, which permits the configuration of sufficiently clear contours of the motive. For example, the cover layer 10 in the height Z can have a thickness of at least 0.3 mm.

On the opposite side of the cover layer 10 a first strength support layer 12 in the form of a woven fabric layer 12 is disposed, the latter serving for regulating the conveying behavior in the printing machine and serving for the shape-related stability in the height Z and in the width of the printing blanket 1. A compressible layer 13 which regulates the hardness of the material of the printing blanket 1 and the conveying behavior of the latter is disposed as the next layer.

Thereafter, a second strength support layer 14 which likewise serves for the dimensional stability in the height Z and in the width as well as additionally in the longitudinal direction Y is provided as a second woven fabric layer 14. An adhesive layer 16 in the form of a double-sided adhesive tape 16 by way of which the printing blanket 1 can be adhesively bonded onto the printing cylinder is disposed on the lower side of the second strength support layer 14.

The second strength support layer 14 has a two-ply woven fabric, the filaments or threads, respectively, thereof lying on top of one another in an alternating manner. On account thereof, punctiform elevations which are surrounded by depressions, or regions that in the height Z are flatter, respectively, are formed in the height Z both in relation to the compressible layer 13 as well as in relation to the adhesive layer 16. In this way, there are only punctiform materially integral contacts at least between the adhesive layer 16 as the double-sided adhesive tape 16 and the second strength support layer 14, on account of which the adhesive effect between these two layers 14, 16 is weakened. Cavities which can receive air are also formed in the second strength support layer 14, the air escaping being able to weaken the dimensional stability of the printing plate 1 in the height Z over the period of operation of the printing plate 10. Also, liquids such as, for example, printing chemicals, can ingress into these cavities and cause the second strength support layer 14 to swell.

FIG. 2 shows a lateral schematic sectional illustration of an ink transfer medium 1 according to an embodiment of the present invention. Instead of the second strength support layer 14 as the second woven fabric layer 14, according to an aspect of the invention a support layer 14 from polyester is disposed between the compressible layer 13 and the adhesive layer 16. Air pockets can be avoided in this way, such that a higher dimensional stability of this layer 15 can be achieved in the longitudinal direction Y, in the transverse direction, and in the height Z. Cavities into which printing chemicals could ingress can also be avoided in this way. This leads to an improved printing quality and to a higher service life of the printing blanket 1 according to the invention.

It is understood that the foregoing description is that of the preferred embodiments of the invention and that various changes and modifications may be made thereto without departing from the spirit and scope of the invention as defined in the appended claims.

### LIST OF REFERENCE SIGNS

### Part of the Description

Y Longitudinal direction, circumferential direction
Z Height, thickness
1 Ink transfer medium, printing blanket, printing plate
10 Cover layer, cover plate
11 Printing side of the cover layer 10
12 First strength support layer, first woven fabric layer
13 Compressible layer
14 Second strength support layer, second woven fabric layer
15 Support layer, film/foil, plastic film, metal foil
16 Adhesive layer, double-sided adhesive tape, adhesive coating

What is claimed is:

1. An ink transfer medium comprising:
a cover layer having a printing side and being configured to transfer an ink via said printing side;
an adhesive layer configured to fasten the ink transfer medium to a base;
a support layer disposed between said cover layer and said adhesive layer and having a first side facing away from said printing side;
said adhesive layer being disposed directly on said first side of said support layer; and,
said support layer being at least one of a film and a foil.

2. The ink transfer medium of claim 1, wherein said at least one of a film and a foil has a smooth surface in relation to said adhesive layer.

3. The ink transfer medium of claim 1, wherein said support layer is a plastic film comprising polyester.

4. The ink transfer medium of claim 1, wherein said support layer is a metal foil comprising metal.

5. The ink transfer medium of claim 1, wherein said adhesive layer is disposed as a double-sided adhesive tape by way of winding.

6. The ink transfer medium of claim 1, wherein said adhesive layer is disposed on said support layer by way of application.

7. The ink transfer medium of claim 1 further comprising a strength support layer disposed between said cover layer and the support layer.

8. The ink transfer medium of claim 1 further comprising a compressible layer disposed between said cover layer and said support layer.

9. The ink transfer medium of claim 7 further comprising a compressible layer disposed between said strength support layer and said support layer.

10. The ink transfer medium of claim 1, wherein said cover layer comprises an elastomeric material.

11. The ink transfer medium of claim 1, wherein said cover layer consists of an elastomeric material.

12. The ink transfer medium of claim 1 further comprising:
a strength support layer;
a compressible layer; and,
wherein said cover layer, said support layer, said adhesive layer, said strength support layer, and, said compressible layer are disposed in the following sequence:
cover layer,
strength support layer,
compressible layer,
support layer, and
adhesive layer.

13. The ink transfer medium of claim 1, wherein the ink transfer medium is a printing blanket.

14. The ink transfer medium of claim 1, wherein the ink transfer medium is a printing blanket for flexographic printing.

15. The ink transfer medium of claim 1, wherein said adhesive layer is configured to fasten the ink transfer medium to a cylinder of a printing machine.

16. The ink transfer medium of claim 1, wherein said support layer is a plastic film consisting of polyester.

17. The ink transfer medium of claim 1, wherein said support layer is a metal foil consisting of metal.
